(19) United States
(12) Patent Application Publication
(10) Pub. No.: US 2004/0084576 A1
(43) Pub. Date: May 6, 2004

(54) Wrist support device

(76) Inventor: Rehan Khan, El Segundo, CA (US)

Correspondence Address: Irving Keschner, Suite 1150, 21515 Hawthorne Boulevard, Torrance, CA, 90503, US

(21) Appl. No.: 10/287,739

(22) Filed: Nov. 5, 2002

(51) Int. Cl. B68G 5/00

(52) U.S. Cl. 248/118; 248/231.71

(57) ABSTRACT

A wrist supporter device which comprises four components; an elongated, shaped metal piece; a flexible material for covering said shaped metal piece; a mounting device and a L-shaped bracket, one leg of the L-shaped bracket being secured to the metal piece. The mounting device has a first knob for securing the device to a supporting member of varying thicknesses. In a first embodiment, a second knob is provided to adjust the device so that it can be secured to supporting members of various thicknesses. In a second embodiment, a second knob allows the metal piece to swivel to a predetermined position and then secure the metal piece to that position.

### BACKGROUND OF THE INVENTION

1. Field of the Invention

The present invention provides a device for supporting the wrist of a person operating a computer accessory, such as a keyboard or mouse.

2. Description of the Prior Art

U.S. Pat. No. 6,131,862 to Gruenenfelder discloses a system for supporting the forearm and wrist of a person operating a computer input-output device, such as a keyboard or mouse. The support member comprises a plastic foam material extending longitudinally and laterally and having a bottom surface for resting on the supporting surface, a top surface adapted for receiving the forearm and/or wrist of the person, a transverse dimension as measured between the top surface and the bottom surface, and a peripheral surface extending between the top surface and the bottom surface. The support member has a total thickness in the range of one to two inches. An outer covering of taut flexible material envelops the support member contiguous to the bottom, top, and peripheral surfaces to restrain against longitudinal and lateral displacement of the plastic foam material when applying force transverse to the support member.

The ergonomic support device disclosed in the Gruenenfelder sits freely on a surface and thus may move as the computer operator adjusts his/her mouse or other accessory. In addition, the support itself is fabricated from a plastic foam material having special characteristics which raises the cost of the support.

What is desired is to provide a wrist support device which is relatively inexpensive to fabricate and which can be securely fastened to items of various thicknesses.

### SUMMARY OF THE PRESENT INVENTION

The present invention provides a wrist supporter device which comprises four components; an elongated, shaped metal piece; a flexible material for covering said shaped metal piece; a mounting device and a L-shaped bracket, one leg of the L-shaped bracket being secured to the metal piece. The mounting device has a first knob for securing the device to a supporting member of varying thicknesses. In a first embodiment, a second knob is provided to adjust the device so that it can be secured to the supporting members of various thicknesses. In a second embodiment, a second knob allows the metal piece to swivel to a predetermined position and then secure the metal piece to that position. The cover provides a soft and comfortable material upon which the user can place his/her wrist and forearm while manipulating a computer mouse or keyboard.

### DESCRIPTION OF THE DRAWING

For a better understanding of the present invention as well as other objects and further features thereof, reference is made to the following description which is to be read in conjunction with the accompanying drawing therein:

FIG. 1 is a perspective view of the wrist support device of the present invention;

FIG. 2 is a cross-sectional view along line 2-2 of FIG. 1;

FIG. 3 is a view along line 3-3 of FIG. 2;

FIG. 4 is a bottom view of the device shown in FIG. 1; and

FIGS. 5-7 illustrate a second embodiment of the present invention.

### DESCRIPTION OF THE INVENTION

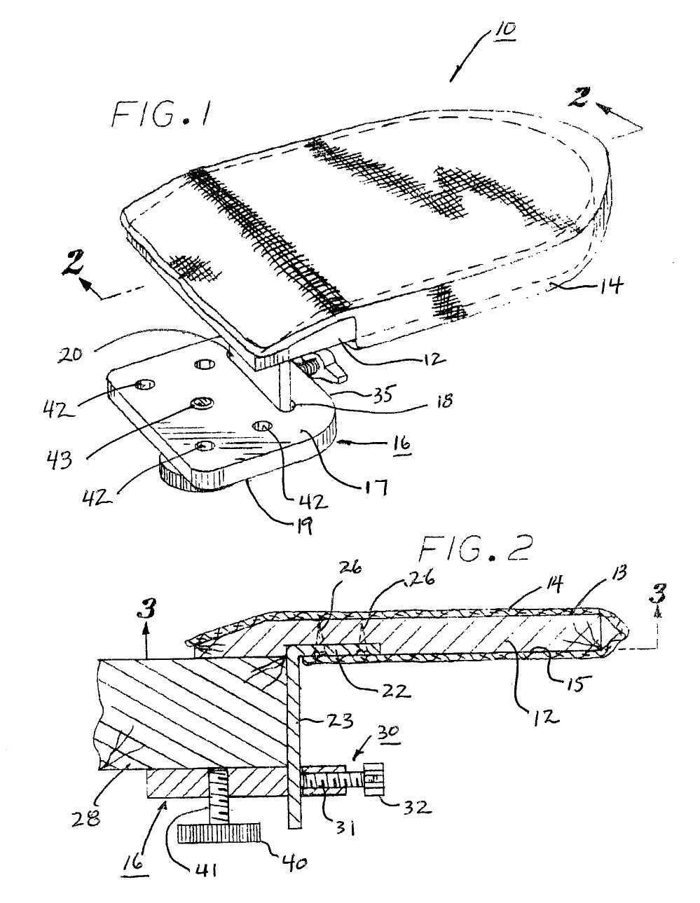

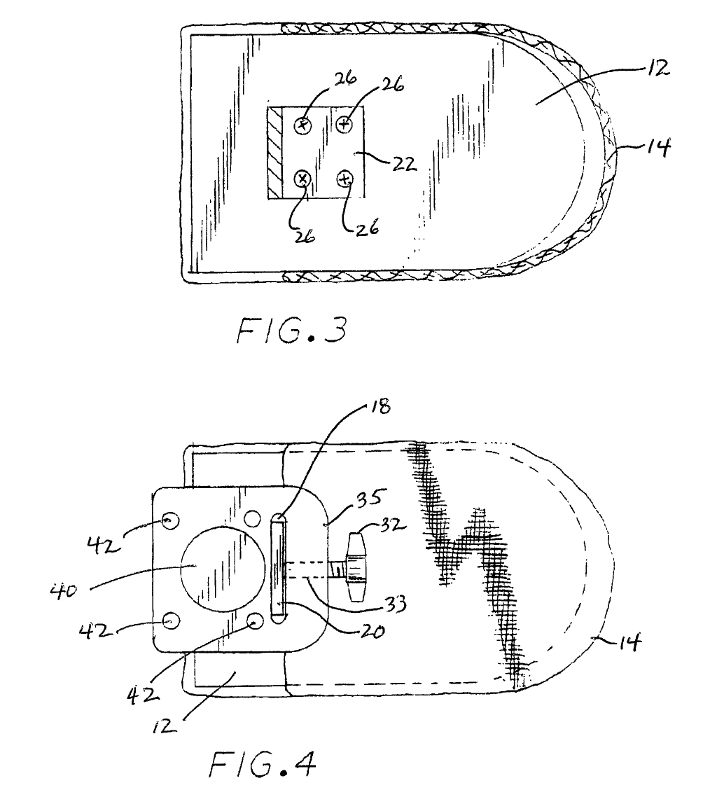

Referring to FIG. 1, a perspective view of the wrist supporter device 10 of the present invention is illustrated. Device 10 comprises an anvil shaped metal support piece 12 having upper surface 13 and lower surface 15 extending in a longitudinal direction and a flexible cover 14, preferably made of leather, that provides a soft and lower flexible support for a user's wrist and forearm. A mounting plate 16 having upper and lower surfaces 17 and 19, respectively, has a slot 18 therethrough which extends between surfaces 17 and 19. A L-shaped bracket 20 has leg portions 22 and 23, leg portion 23 extending through slot 18 formed in plate 16. Leg portion 22 of L-shaped bracket 20 extends into a notch, or opening, formed in lower surface 15 of metal support piece 12. Leg 22 is secured to the inside surface of piece 12 with a plurality of screws 26 through holes formed in the lower, or bottom, surface 15 of piece 12. Mounting plate 16 has a plurality of holes 42 connecting surfaces 17 and 19 formed therein.

FIG. 2 illustrates device 10 clamped to an object, such as table 28, using mounting plate 16. An adjustable clamp member 30 comprises a screw member 32 having a threaded shaft 31 which extends into an opening 33 (FIG. 4) formed in end 35 of mounting plate 16. Threaded shaft 31 is coupled to L-shaped bracket 20 in a manner such that the spacing between upper surface 17 of bracket 20 and lower surface 15 of support piece 12 can be adjusted to accommodate various thicknesses of object 28. Threaded shaft 41 of adjustable knob 40 is positioned within opening 43 formed in mounting plate 16; rotation of knob 40 forces shaft 41 against the lower surface of object 28 such that device 10 is secured thereto.

If it is desired to permanently secure device 10 to object 28, fasteners may be inserted through holes 42 formed in mounting plate 16 and screwed into table 28 in a conventional manner.

In use, device 10 is secured to object 28 or other surface upon which is supported a computer or computer monitor in the manner noted hereinabove. The user then positions himself/herself such that his/her wrist is positioned on the surface of the covered support piece 12, the user's fingers then operating the keyboard or mouse as required in a conventional manner.

Typical dimensions for the components of device 10 are as follows:

L-shaped bracket 20: length, 2.750 inches; width 1.125 inches; full radius; thickness 0.188 inches; leg 22; 1.250 inches long.

Mounting plate 12: width 4.000 inches; height from base to centerline 3.000 inches; radius 2.00 inches.

Clamping plate 16: width 2.375 inches; length 2.500 inches; slot length 1.250 inches, slot width 0.188 inches.

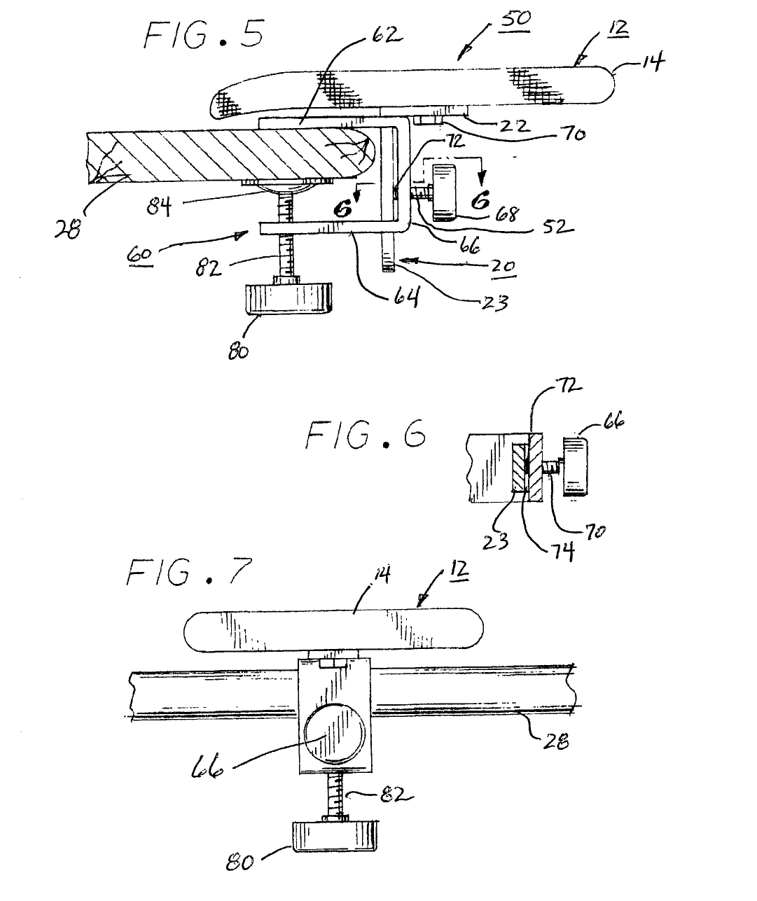

FIG. 5 is a side elevation view of a second embodiment 50 of the present invention (the same reference numerals in the figures identify identical components). In this embodiment, leg 22 of bracket 20 is secured directly to the bottom surface of the metal piece 12 by fastener 52. A C-clamp 60 comprising leg portions 62 and 64 and base 66 is provided to mount the covered metal piece 12 to the table, or desk, 28 and to enable the covered metal piece 12 to be swiveled, or rotated, to a desired position. Leg 23 of L-shaped bracket 20 extends through aligned openings formed in C-clamp portions 62 and 64. This enables the height of metal piece 12 above the top surface of the desk 28 to be adjusted; once the desired height is reached, knob 68, having a threaded shaft 70, is rotated in a manner such that tip 72 of shaft 70 is positioned in contact with surface 74 of leg 23 as illustrated in FIG. 6. Fastener 80, having a threaded shaft 82 and contact cup portion 84, secures device 50 to table 28 as illustrated. In addition, when knob 80 is rotated such that cups 84 is no longer in contact with the bottom surface of table 28, the user can swivel metal piece 12 to a desired angular position about the axis of threaded shaft 82.

FIG. 7 is a right side view of the device shown in FIG. 5.

The present invention thus provides a support system that makes the use of a mouse or other computer input-output device as comfortable and relaxing, enabling the user to operate the mouse or other device for long periods of time without suffering wrist fatigue, normally attendant with such use.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A device for receiving and supporting the forearm and wrist of a person engaged in operating apparatus positioned on the surface of a support member comprising:
a first shaped support, said support having first and second surfaces, an opening being formed in said second surface;
a L-shaped member having first and second leg portions; and
a mounting plate for mounting said support to second support member, said mounting plate having a slot formed therein, said first leg portion of said L-shaped member extending through said opening, said second leg portion of said L-shaped member extending through the slot formed in said mounting plate.

2. The device of claim 1 wherein a flexible member covers the first surface of said shaped support.

3. The device of claim 1 wherein said mounting plate has an upper and lower surface, a plurality of openings being formed to connect said upper and lower surfaces.

4. The device of claim 3 wherein an adjustment member is positioned through one of said openings to secure said device to said support member.

5. The device of claim 3 wherein fasteners are inserted through selected openings to secure said device to said support member.

6. The device of claim 1 wherein said mounting plate has a first edge, an opening being formed in said edge and wherein a fastener member extends through said opening into engagement with said second leg portion of said L-shaped member in a manner to secure said mounting plate at a predetermined distance from the bottom surface of said shaped support.

7. A device for receiving and supporting the forearm and wrist of a person engaged in operating apparatus positioned on the surface of a support member comprising:
a first shaped support, said support having first and second surfaces;
a L-shaped member having first and second leg portions; and
a mounting device for mounting said support to second support member, said mounting device having slots formed therein, said first leg portion of said L-shaped member being secured to said second surface of said first shaped support, said second leg portion of said L-shaped member extending through said slots formed in said mounting device.

8. The device of claim 7 wherein a flexible member covers the first surface of said shaped support.

9. The device of claim 7 wherein said mounting device has first and second leg portions and a base portion, an opening being formed in said first leg portion.

10. The device of claim 9 wherein an adjustment member is positioned through said openings wherein one end is in contact with said second surface of said support member thereby securing said device to said support member.

11. The device of claim 10 wherein said device can swivel about the vertical axis of said adjustment member when said one end is not in contact with said second surface of said support member.

12. The device of claim 7 wherein an opening is formed in said base portion of said mounting device, a fastening member being secured in said opening into engagement with said second leg portion of said L-shaped member in a manner to enable said first shaped support to be positioned at a predetermined height above said first surface of said support member.
